(19) United States
(12) Patent Application Publication
(10) Pub. No.: US 2026/0091895 A1
(43) Pub. Date: Apr. 2, 2026

(54) WIRELESS POWER AND BI-DIRECTIONAL COMMUNICATION HUB AND DEVICES THEREFORE

(71) Applicant: THE BOARD OF TRUSTEES OF THE UNIVERSITY OF ILLINOIS, URBANA, IL (US)

(72) Inventors: Dieff Vital, Chicago, IL (US); Danilo Erricolo, Chicago, IL (US)

(73) Assignee: THE BOARD OF TRUSTEES OF THE UNIVERSITY OF ILLINOIS, URBANA, IL (US)

(21) Appl. No.: 18/881,294

(22) PCT Filed: Jul. 10, 2023
(86) PCT No.: PCT/US2023/027242

§ 371 Date: Jan. 5, 2025

Related U.S. Application Data
(60) Provisional application No. 63/359,478, filed on Jul. 8, 2022.
(60) Provisional application No. 63/430,560, filed on Dec. 6, 2022.
(60) Provisional application No. 63/468,445, filed on May 23, 2023.

(51) Int. Cl. B64U 50/38; B64U 80/25; H01Q 1/28; H01Q 19/30; H02J 50/00; H02J 50/12; H02J 50/23; H02J 50/50; H02J 50/90

(52) U.S. Cl. CPC B64U 50/38; B64U 80/25; H01Q 1/28; H01Q 19/30; H02J 50/001; H02J 50/12; H02J 50/23; H02J 50/50; H02J 50/90

(57) ABSTRACT

The disclosure provides an example charging nest for wireless power transfer to drones is disclosed. The charging nest includes (a) a housing having an opening at a first end, (b) a plurality of antennas arranged around a periphery of the housing with each antenna aperture arranged facing a center of the housing, where each of the plurality of antennas has a director, an exciter, and a plurality of reflectors, and (c) a plurality of transmitters or transceivers each electrically coupled to a corresponding exciter of the plurality of antennas.

### CROSS-REFERENCE TO RELATED APPLICATIONS

This application is an International PCT Application that claims priority to U.S. Provisional Application No. 63/359,478, filed on Jul. 8, 2022, to U.S. Provisional Patent Application No. 63/430,560, filed on Dec. 6, 2022, and to U.S. Provisional Application No. 63/468,445, filed on May 23, 2023, that are each hereby incorporated by reference in their entirety.

### BACKGROUND

Conventional wireless chargers operate using electromagnetic induction and require placement of devices on a charging pad or pad-like device.

### SUMMARY

Charging nests for misalignment-free wireless charging and bi-directional communication are provided herein. The charging nests can be configured for bi-directional communication with any suitable device, including unmanned arial vehicles (“UAVs”), vehicles, robots, IoT devices, and wearables, for example. The charging nests enable long-distance and fast charging of swarms of UAVs that may increase flight time and on-site performance.

The charging nests further eliminate the need for specific placement on a conventional charging pad to advantageously permit misalignment-free wireless charging for phones, tablets, and other IoT devices.

In a first aspect of the disclosure, an example charging nest for wireless power transfer to drones is disclosed. The charging nest includes (a) a housing having an opening at a first end, (b) a plurality of antennas arranged around a periphery of the housing with each antenna aperture arranged facing a center of the housing, where each of the plurality of antennas has a director, an exciter, and a plurality of reflectors, and (c) a plurality of transmitters or transceivers each electrically coupled to a corresponding exciter of the plurality of antennas.

In a second aspect of the disclosure, an example charging nest for wireless charging is disclosed. The charging nest includes (a) a housing that is circular or ring-shaped, (b) a plurality of antennas arranged about a periphery of the housing, (c) at least one signal generator and at least one RF power amplifier electrically coupled to the plurality of antennas, and (d) at least one sensor electrically coupled to the at least one signal generator, where the at least one sensor is configured to detect a device-for-charging (“DFC”) and a location associated with a receiver coupled to the DFC and to communicate the location to the signal generator to facilitate beam-steering.

In a third aspect of the disclosure, an example charging nest for wireless charging is provided. The charging nest includes (a) a housing and (b) at least one spherical antenna array arranged within the housing. The spherical antenna array includes a plurality of antennas arranged at an angle α relative to each other such that the at least one spherical antenna array provides elevational charging and azimuthal charging.

In a fourth aspect of the disclosure, an example resonator for wireless power transfer and harvesting is provided. The resonator includes a single-loop resonator coupled to a plurality of semi-circular resonators evenly spaced about a periphery of the single-loop resonator thereby concentrating electric and magnetic fields in a center of the single-loop resonator and/or along the periphery of the single-loop resonator.

In a fifth aspect of the disclosure, an example wearable antenna array is provided. The wearable antenna array includes (a) a plurality of resonators according to the fourth aspect of the disclosure coupled to a textile, (b) a plurality of fluid-based actuators each coupled to a first side of one of the plurality of resonators, where each fluid-based actuator comprises a multi-channel platform having at least four channels each formed from a compartment made of polymer that each contains a fluid; and (c) a plurality of radiators each coupled to one of the plurality of fluid-based actuators and to one of the plurality of resonators, where each radiator comprises a multi-compartment loop.

The features, functions, and advantages that have been discussed can be achieved independently in various examples or may be combined in yet other examples further details of which can be seen with reference to the following description and drawings.

### BRIEF DESCRIPTION OF THE DRAWINGS

FIG. 1 depicts a perspective view of a charging nest, according to an example implementation;

FIG. 2 depicts a front perspective view of the charging nest in FIG. 1, according to an example implementation:

FIG. 3 depicts rear view of the charging nest in FIG. 1, according to an example implementation;

FIG. 4 depicts a cross-sectional view of the charging nest having a circular array of Yadish antennas and a detail view of a Yadish antenna, according to an example implementation:

FIG. 5 depicts the Yadish antenna as utilized in a transmitter and a receiver, according to an example implementation:

FIG. 6A depicts a graph of wireless power transfer efficiency (“WPTE”) performance versus frequency, according to an example implementation:

FIG. 6B depicts a graph of the performance of the charging nest according to FIG. 1 when subject to lateral misalignment along the x-axis;

FIG. 6C depicts a graph of the performance of the charging nest according to FIG. 1 when subject to lateral misalignment along the y-axis:

FIG. 6D depicts a graph of the performance of the charging nest according to FIG. 1 when subject to lateral misalignment along the z-axis:

FIG. 7 depicts a cross-section view of the electric field distribution of the charging nest of FIG. 1, according to an example implementation:

FIG. 8 depicts a perspective view of the electric field distribution of the charging nest of FIG. 1, according to an example implementation:

FIG. 9 depicts a top cross-sectional view along the length of the charging nest of FIG. 1, according to an example implementation;

FIG. 10 depicts a cross-sectional view of the charging nest having a circular array of Yadish antennas, according to an example implementation;

FIG. 11 depicts a top view of a charging nest, according to one example implementation:

FIG. 12 depicts a front perspective view of the charging nest of FIG. 11, according to one example implementation;

FIG. 13 depicts a front perspective view of a charging nest, according to one example implementation:

FIG. 14 depicts a top view of the charging nest of FIG. 13 surrounded by the receivers of devices-for-charging for elevational charging, according to one example implementation:

FIG. 15 depicts a front view of the charging nest of FIG. 13 surrounded by the receivers of devices-for-charging for azimuthal charging, according to one example implementation:

FIG. 16 depicts a top view of a charging nest, according to one example implementation:

FIG. 17 depicts the charging nest of the second aspect of the disclosure arranged at the top of a tower, according to one example implementation;

FIG. 18 depicts a plurality of charging nests according to the second and/or third aspects of the disclosure arranged and embedded throughout a spiral parking lot:

FIG. 19A depicts the magnetic fields (H-fields) distributed within the nest-like resonator (max(H_{field})=3.5 A/m) (c) E-fields distributed within the nest, and (d) E-fields distributed within the loop. Dimensions of the nest-like resonator are Radius_{big-loop}=14.7 cm, Radiusₛₘₐₗₗ₋ₗₒₒₚ=4.676 cm, thickness_{big-loop}=0.5995 cm, and thicknessₛₘₐₗₗ₋ₗₒₒₚ=0.324 cm;

FIG. 19B depicts the magnetic fields (H-fields) distributed within the loop (max(H_{field})=3.5 A/m). Dimensions of the loop are Radius=14.7 cm and thickness=0.5995 cm:

FIG. 19C depicts the electric fields (E-fields) distributed within the nest-like resonator of FIG. 1A (max(E_{field})=1200 V/m);

FIG. 19D depicts the electric fields (E-fields) distributed within the loop of FIG. 1B (max(E_{field})=1200 V/m):

FIG. 20A depicts a graph comparing the power transfer efficiency for the nest-like resonator and the loop due to lateral misalignment in the direction parallel to the RF feeding;

FIG. 20B depicts a graph comparing the power transfer efficiency for the nest-like resonator and the loop due to diagonal misalignment;

FIG. 21A depicts a graph showing the performance of the power harvesting circuit with RF-to-DC conversion efficiency (Z₀=500, fᵣ=433 MHz, C₁=10 pF, TL₁=7.13 mm×35.03 mm, C₂=3.9 pF, TL₂=1 mm×45.26 mm, L=33H, and R_{L}=297.865Ω);

FIG. 21B depicts a graph showing the performance of the power harvesting circuit with the collected DC voltage level:

FIG. 22 depicts multiple embodiments for the resonator and the magnetic field (max(H_{field})=3.5 A/m) spanning from the fringe-enabling demi-loops incorporated in the single loop. Dimensions of the resonators: Radius_{big-loop}=14.7 cm, Radiusₛₘₐₗₗ₋ₗₒₒₚ=4.676 cm, thickness_{big-loop}=0.5995 cm, and thicknessₛₘₐₗₗ₋ₗₒₒₚ=0.324 cm.

FIG. 23 is a schematic that depicts the centipedic resonator in an electromagnetics-on-clothing hub for sensors and internet of medical things:

FIG. 24A depicts the WPTE characterization for each of the single-loop, nest-inspired, and palm-tree-leaf resonators for misalignment type Y-move;

FIG. 24B depicts the WPTE characterization for each of the single-loop, nest-inspired, and palm-tree-leaf resonators for misalignment type X-move:

FIG. 24C depicts the WPTE characterization for each of the single-loop, nest-inspired, and palm-tree-leaf resonators for misalignment type diag-move;

FIG. 25 depicts a fluidically reconfigurable harvesting jacket made of a 3×2-reconfigurable antenna array actuated by fluid with the following applicable dimensions: Radius A=12 cm, Radius B=13 cm, Radius C-6 cm. Radius D=12 cm, Radius E=12 cm, and Radius F=13 cm:

FIG. 26A depicts a simulated performance of the proposed reconfigurable antenna when no fluid is used versus fluid-based actuation for |Sul of the non-actuated antenna (no fluid) and realized gain of the antenna (linear scale);

FIG. 26B depicts a simulated performance of the proposed reconfigurable antenna when no fluid is used versus fluid-based actuation when channels 1 & 3 are actuated by distilled water (D) and salt water(S);

FIG. 26C depicts a simulated performance of the proposed reconfigurable antenna when no fluid is used versus fluid-based actuation when channel 1 is S-actuated:

FIG. 26D depicts a simulated performance of the proposed reconfigurable antenna when no fluid is used versus fluid-based actuation when channel 1 is D-actuated;

FIG. 26E depicts a simulated performance of the proposed reconfigurable antenna when no fluid is used versus fluid-based actuation when channel 3 is D-actuated; and

FIG. 26F depicts a simulated performance of the proposed reconfigurable antenna when no fluid is used versus fluid-based actuation when channels 2 & 3 are D-actuated.

The drawings are for the purpose of illustrating examples, but it is understood that the disclosure is not limited to the arrangements and instrumentalities shown in the drawings.

### DETAILED DESCRIPTION

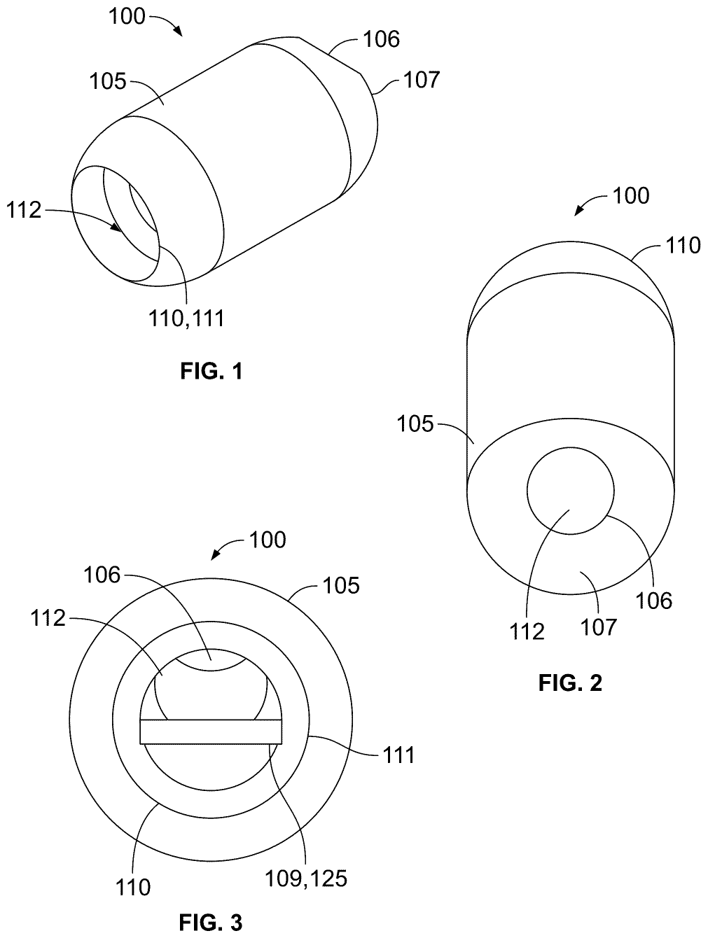

In a first aspect of the disclosure, shown in FIGS. 1-10, a charging nest 100 for wireless power transfer to drones 101 includes a housing 105 having an opening 106 at a first end 107. The charging nest 100 also includes a plurality of antennas 115 arranged around a periphery 108 of the housing 105 with each antenna aperture arranged facing a center 109 of the housing 105. As used herein, the “antenna aperture” refers to that portion of a plane surface near the antenna 115, perpendicular to the direction of maximum radiation (i.e., the beam 113), through which the major part of the radiation passes. Each of the plurality of antennas 115 has a director 116, an exciter 117, and a plurality of reflectors 118. The charging nest 100 further includes a plurality of transmitters or transceivers 120 each electrically coupled to a corresponding exciter 117 of the plurality of antennas 115. As used herein, “electrically coupled” refers to coupling using a conductor, such as a wire or a conductible trace, as well as inductive, magnetic, and wireless couplings.

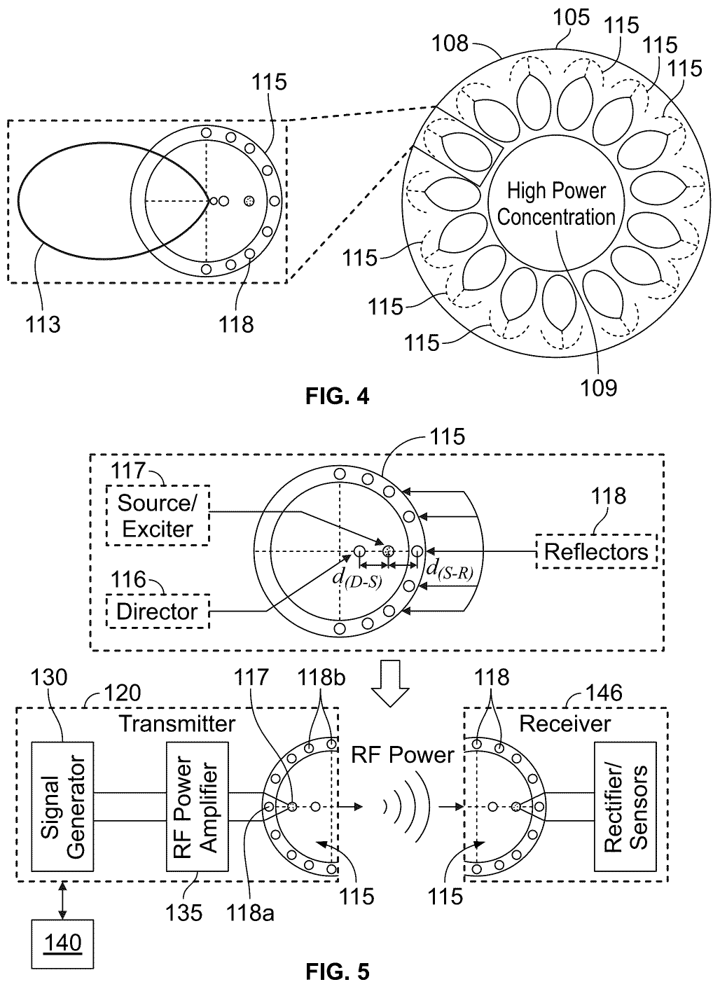

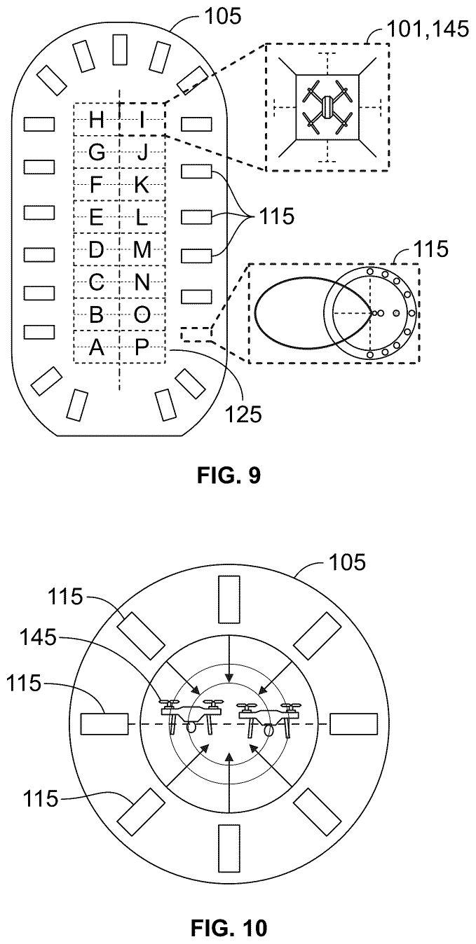

In one optional implementation, as shown in FIGS. 1-3 and 9, the housing 105 is cylindrical, and the plurality of antennas 115 are arranged in a circular array, as shown in FIGS. 4 and 10. In a further implementation, the circular array of the plurality of antennas 115 extends along a length of the housing 105, as shown in FIG. 9. In one optional implementation, as shown in FIGS. 1-3 and 9, the first end 107 and the second end 110 of the housing 105 are hemispherical. Antennas 115 disposed in the hemispherical ends 107, 110 of the housing 110 may provide further diversity in distribution of charging signals in contrast to a housing 110 having straight capped ends.

In one optional implementation, each of the plurality of antennas 115 is a Yagi-Uda antenna. In one implementation, shown in FIGS. 4-5 and 9, the plurality of reflectors 118 for each of the plurality of antennas 115 includes at least nine reflectors 118. In a further implementation, the plurality of reflectors 118 for each of the plurality of antennas 115 are arranged in a semi-circle relative to the exciter 117. In this implementation, the plurality of reflectors 118 for each of the plurality of antennas 115 may include a main reflector 118a aligned with the exciter 117 and a plurality of auxiliary reflectors 118b evenly distributed on either side of the main reflector 118a along the semi-circle.

In one optional implementation, a second end 110 of the housing 105 is sealed. In an alternative implementation, the second end 110 of the housing 105 may have an opening 111 that acts as an entrance and/or an exit for drones 101, 145 or other unmanned aerial vehicles, for example. The opening 106 in the first end 107 and the opening 111 in the second end 110 of the housing 105 may each have a retractable door that is motion activated to help reduce radiation exposure in the surrounding environment.

In one optional implementation, as shown in FIGS. 3 and 10, the charging nest 100 includes at least one platform 125 arranged in the center 109 of the housing 105 and coupled to an interior wall 112 of the housing 105. As shown in FIG. 10, the platform may include a plurality of landing zones for drones 101, 145.

In one optional implementation, as shown in FIG. 5, the charging nest 100 further includes at least one signal generator 130 and at least one RF power amplifier 135 electrically coupled to the plurality of antennas 115. And the charging nest 100 includes at least one sensor 140 electrically coupled to the at least one signal generator 130. The at least one sensor 140 is configured to detect a device-for-charging (“DFC”) 145 within the housing 105 and a location associated with a receiver 146 coupled to the DFC 145 and to communicate the location to the signal generator 130 to facilitate beam-steering.

### Example 1: A Charging Nest Made of Novel Dish-Backed Yagi-Uda Antennas for Misalignment-Resilient Wireless Power Transfer for Drone Charging

### I. Introduction

A wireless power system that addresses the challenge of misalignment. This system, known as a pill-shaped nest, comprises a circular array of dish-backed Yagi-Uda antennas designed to operate at 433 MHz. The circular array enables the concentration of electric and magnetic fields at the center of the nest, enabling rapid charging of drone swarms. The antennas are meticulously designed and simulated at 433 MHz, demonstrating high efficiency even when subjected to lateral misalignment of up to 3 degrees. The simulation results indicate that the wireless power system can achieve an efficiency of up to 85% for misalignment distances of up to 17 cm. This impressive performance makes it possible to charge drones efficiently despite slight misalignments. The system boasts several advantageous features, including its low-profile design, resilience to misalignment, and cost-effectiveness. Moreover, it can power a wide range of unmanned aerial vehicles (UAVs) and can be deployed at any location. These qualities make it an appealing solution for UAV systems that require reliable charging. The significance of these results cannot be understated, as they represent an initial step toward addressing the issue of extended flight time for drones. This wireless power system has the potential to support critical operations such as package delivery, disaster relief and rescue efforts, law enforcement activities, military operations, and other systems that demand wireless, fast, and continuous charging.

In recent years, Unmanned Aerial Vehicles or drones have gained a lot of popularity due to their usability in many applications ranging from surveillance monitoring, delivery, search and rescue operations, aerial photography to wireless communications. However, UAVs have limited battery life on board, which restricts their flight time and operations, especially in remote areas or hard-to-reach places because they need human intervention to physically swap batteries. In effect, the use of drones is very limited in life-saving events like disaster relief including fire rescue, camping and hiking rescue, etc. Wireless charging offers a more reliable and flexible way for charging UAVs and other vehicles. It is safer and easy to set up, especially in places where interconnecting wires are not possible.

There are several proposed solutions to charge drone batteries, and they are categorized into two: Non-Electromagnetic Field (EMF) charging and EMF charging. Non-EMF based charging methods do not involve electromagnetic fields to transfer energy: such as, installing photovoltaic (PV) arrays on the UAV, wind gust soaring in which drones gain energy from the wind, and energy beamed on PV cells using lasers. These charging methods depend on outside power sources like solar radiation and wind that are not suitable nor reliable in case of continuous bad weather conditions. On the other hand, EMF-based charging refers to using electromagnetic fields to transfer energy, using magnetic resonant coupling, inductive coupling, or capacitive coupling. These are near-field techniques in which energy is transferred within a few centimeters of range. An example of far-field technique is the use of laser-based wireless power transfer to power drones at up to 500 meters away but they come with a high-power consumption for the laser module (87.75% of the input power) to output 73.5 W to power the drones. When compared with far-field EMF techniques, near field techniques have a higher power transfer and are safer for the human body and more reliable, which makes them suitable for charging UAVs.

Using the aforementioned powering techniques comes with some concerns including the fact that the charging platforms are open in the air, which makes them hazardous for human beings should they happen to be around.

Although the near-field wireless power transfer method enabled more than 80% of power transfer efficiency and excellent SAR level, the developed prototypes cannot house multiple drones for charging purposes. Therefore, developing a new method of rapid-powering a swarm of drones while shielding humans from radiation exposure is a must. In this paper, a new wireless power charging method for a swarm of drones with shielding capabilities to human exposure to radiations is proposed. The resulting device is a pill-shaped nest (see FIGS. 1-10) made of a new antenna topology known as dish-backed Yagi-Uda or Yadish to (1) enable fast charging, (2) charge a swarm of drones, (3) be placed on any surface and at any location to cater to the charging need of these drones while in transit, (4) eliminate battery swap, and (5) eliminate human exposure. This newly proposed wireless charging method can be used to power swarms of drones deployed for package distribution as reported in the recent patents filed by Amazon.

The disclosed antenna topology that has 9-reflectors arranged circularly behind a 3-element Yagi-Uda antenna and organized in an array for better power transfer efficiency (higher gain) to operate at a frequency of 433 MHz. In effect, when a transmitter (Tx) and a receiver (Rx) are separated by a distance of 17 cm, the resulting wireless power transfer efficiency (WPTE) was found to be around 85%. When the Tx and Rx are subject to misalignment, the WPTE is found to be constant regardless of the degree of misalignment. The result suggests that the disclosed dish-backed Yagi-Uda antenna is a good candidate for near-field charging of UAVs.

### II. The Disclosed Antenna Topology: 9-Reflector Dish-Backed Yagi-Uda

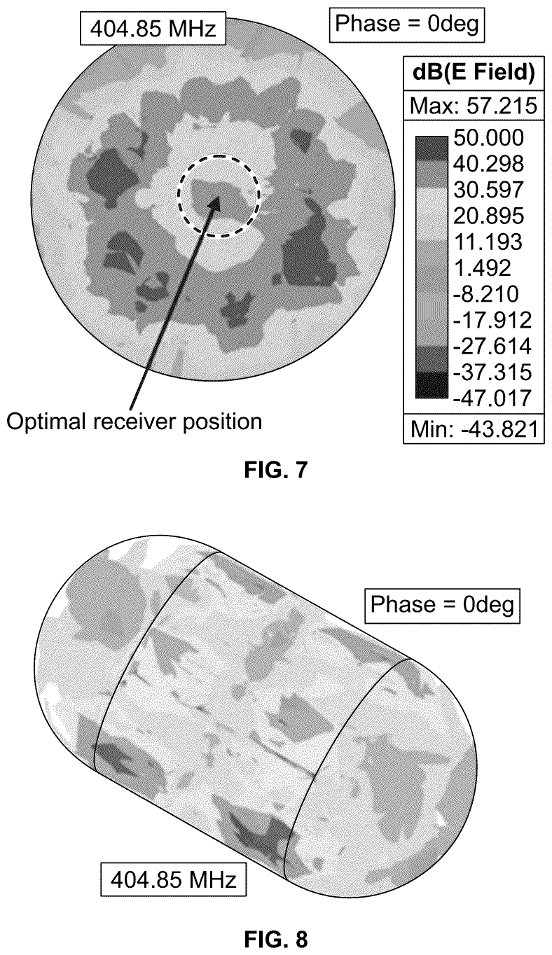

The disclosed antenna topology, Yadish is derived from a 3-element Yagi-Uda antenna with extra reflectors placed in a semi-circular fashion to achieve better WPTE. When these antennas are placed in a circular fashion with the aperture facing the center of the circle, as shown in FIGS. 4 and 10, this allows for a cluster of electric and magnetic fields to provide fast charging to multiple UAVs. The charging nest was designed and simulated using Ansys/HFSS and the electric field distribution was reported in FIGS. 7-8. The design evolution and the contribution of each element (director, exciter, and reflector) on the total wireless power transfer efficiency (ηₜₒₜₐₗ) was considered (see FIG. 5 top image). For the dish-like backing, the nine (9) reflectors are placed in such a way that the main reflector (R_{M}) is aligned with that exciter (source) and the other reflectors, referred to as auxiliary reflectors (Rₜ) are placed on both sides of R_{M}. The design and simulation process started as follows:

(1) First, two half-wavelength dipoles (bare dipoles) were placed at 3 spacings away from each other where each spacing is equal to one eighth of a wavelength (see Table I). The scattering parameters were extracted and the WPTE (η_{d}) was evaluated using the following equation:

$$η = {\vert {S}_{21} \vert}^{2} \times 1 \; 00 \% . \qquad ( 1 )$$

The bare dipoles are expected to exhibit a WPTE of at most 50% (with no path loss) as their field distribution is the same in the azimuthal plane. The omnidirectional aspect makes the system suffer from further power deterioration. Therefore, it is expected that η_{d}<<50%.

(2) Second, two directors were placed between the bare dipoles at one spacing from each other. The bare dipoles kept their fixed distance and the scattering parameters were extracted to evaluate the WPTE (η_{D}). As the director will be coupled with the source to direct the power in the direction of maximum sensitivity, no is expected to be a multiple of η_{d}. The expression of η_{D}=aη_{d}, where a represents the improvement index caused by adding the director.

(3) Third, two reflectors are placed behind the bare dipoles without the directors. Each of them was at two spacings (≈λ/4) from each dipole. With the bare dipole keeping their fixed distance, the scattering parameters were extracted and the WPTE (ηR_{M}) was evaluated. ηR_{M} was expected to be much higher than η_{d} due to the effect of image theory on printed dipoles that mounts to a gain increase by up to 6 dB (4x). The expression of ηR_{M}=bη_{d}, where b represents the improvement index caused by adding the reflector.

(4) Fourth, more reflectors are added on both sides of each main reflector to further improve the WPTE. Four auxiliary reflectors are added on both sides of each main reflector, which amounts to a total of nine (9) reflectors circularly placed behind each dipole to exploit the effect of convergent mirror for WPTE improvement. At this point, the WPTE of the system when more reflectors are added may be improved and the expression of the total efficiency will be:

$$\begin{matrix}{η}_{Y adish} = η ( d , D , {R}_{i} ) , i = 1 , … , M , … , n \\ = {η}_{total} \\ = {\vert {S}_{21} ( Y adish ) \vert}^{2} \times 100 \%\end{matrix} . \qquad ( 2 )$$

TABLE I
Summary of the parameters and dimensions
of the disclosed antenna

| Parameters | Values (units) |
|---|---|
| Resonant frequency | 433 MHz |
| Wavelength (free-space) | λ = 69.284 cm |
| One spacing | 0.125 λ |
| Conductor width | 0.0081λ |
| Director length | 0.44λ |
| Exciter (Source) length | 0.473λ |
| Reflector length | 0.495λ |

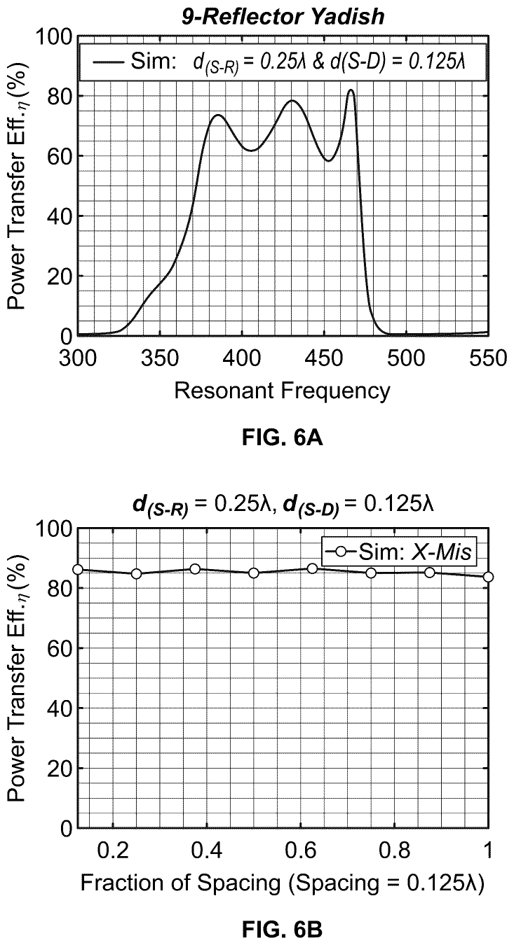

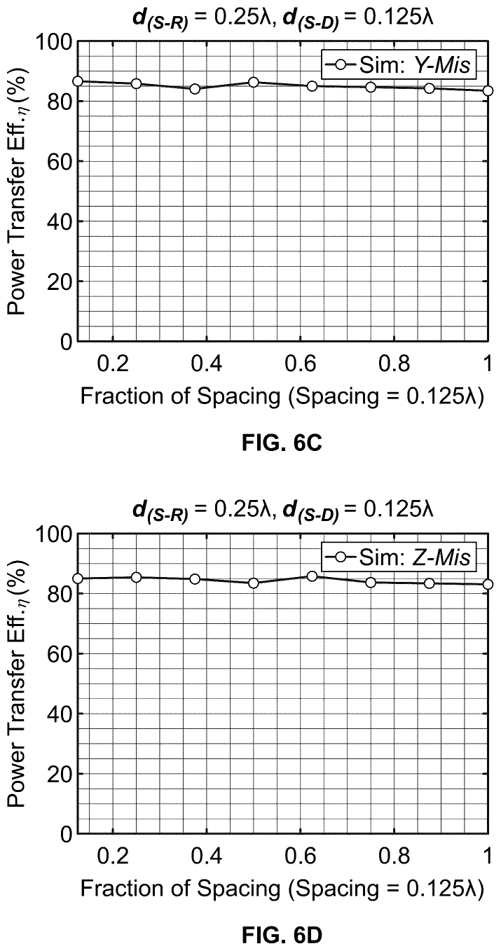

The dimensions of the director, exciter, and the reflectors are shown in Table I. To evaluate the performance of the proposed system, two Yadish antennas were designed and simulated using Ansys. The WPTE was evaluated using equation (1), as shown in FIG. 6A. In addition, the influence of the misalignment along the x-, y-, and z-axis was studied and the corresponding WPTE was reported in FIGS. 6B-6D, respectively. The influence of lateral misalignment was studied when the system was subject to misalignment along the aforementioned axes. As presently disclosed, d_{C-C} was defined as the fixed distance between the bare dipoles from the Tx and Rx, and dₓ, d_{y}, and d_{z} when they are subject to misalignment in the X, Y, and Z axes, respectively. The total distance between the bare dipoles when they are subject to misalignment will be then:

$${d}_{C - C}^{x} = \sqrt{{d}_{C - C}^{2} + {d}_{x}^{2}} \qquad ( 3 )$$

$${d}_{C - C}^{y} = \sqrt{{d}_{C - C}^{2} + {d}_{y}^{2}} \qquad ( 4 )$$

$${d}_{C - C}^{z} = {d}_{C - C} + {d}_{z} \qquad ( 5 )$$

### III. Wireless Power Transfer Performance and Discussion

The wireless power transfer performance of the system was evaluated using equation (1). As shown in FIG. 6A, a peak WPTE of 80% was observed when the two Yadish antennas were separated by a distance of three spacings with no misalignment influence. In addition, the influence of misalignment on the WPTE exhibited by the system along the x-, y-, and z-axes was calculated using equations (3), (4), and (5), respectively. As depicted in FIGS. 6B-D, the system exhibited a WPTE of around 85% for misalignment along all the axes and the results are constant on average when the misalignment distance increases. These results are similar to or better than those previously observed. The salient features of the proposed system include the following:
(1) Low profile. Antennas can be built from copper rods cut at certain sizes with no need for expensive substrate materials,
(2) Cost effectiveness. Low-cost copper rods, solder, and inexpensive SMA connectors are the only materials needed,
(3) Ability to be placed anywhere like atop of houses, forests, stadiums, military compounds, etc.,
(4) Ability to house arrays of antennas for fast charging for swarms of drones, and
(5) Ability to shield human beings from exposure to radiation.

In addition to the aforementioned salient aspects, the unit antenna performs better than those previously known that used additional structures like meta-surfaces, beam-forming, planar transmitting array, and the arrangement of relay resonators in domino form. The disclosed pill-shaped housing is versatile and can utilize any antenna regardless of the topology. This makes the system the perfect candidate for any system in need of wireless, fast, and continuous charging.

### IV. Conclusion

A novel charging system, referred to as a pill-shaped charging nest is proposed to operate at 433 MHz. The charging nest utilizes the presently disclosed antenna topology, Yadish designed by placing a semi-circular backing of nine (9) reflectors behind a 3-element Yagi-Uda antenna. By placing the circular backing behind the 3-element Yagi-Uda, an average WPTE of 85% was found even when the system was subject to three (3) degrees of lateral misalignment. The low-profile aspect of the system, its high efficiency, cost efficiency, the ability to shield human beings from radiation exposure, ability to charge swarms of drones, and the ability to be placed anywhere make it appealing to any system in need of wireless charging.

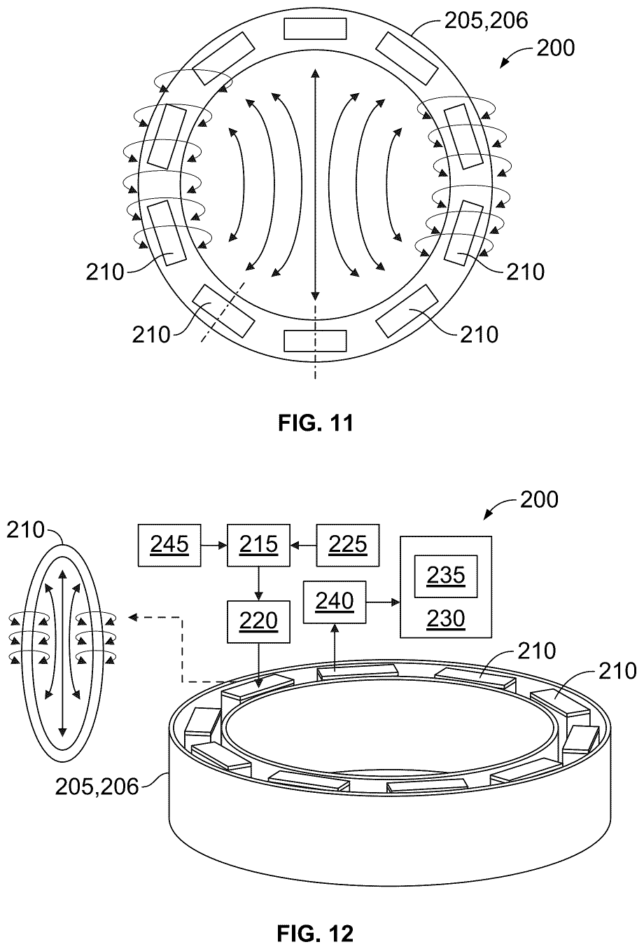

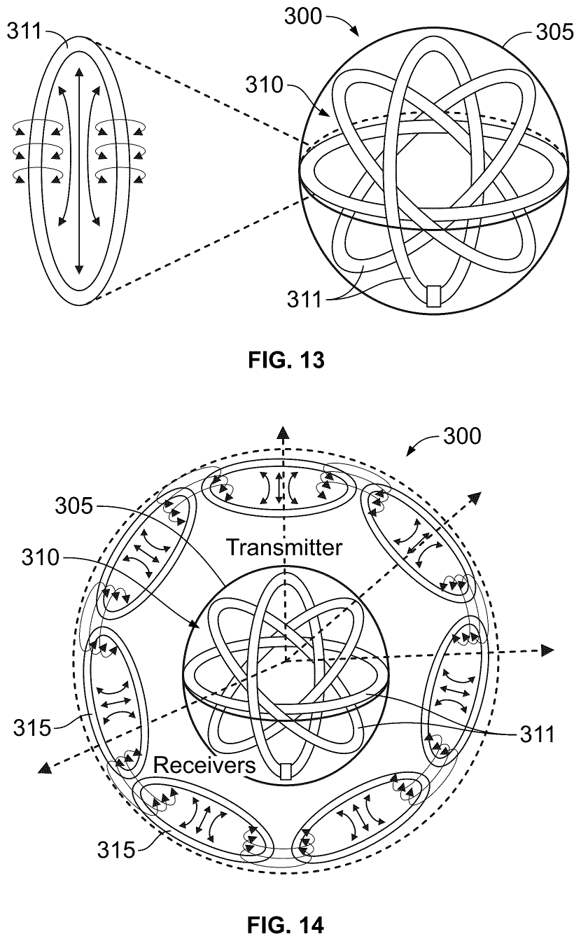

In a second aspect of the disclosure, shown in FIGS. 11-12, a charging nest 200 for wireless charging includes a housing 205 that is circular or ring-shaped. The charging nest 200 also includes a plurality of antennas 210 arranged about a periphery 206 of the housing 205. The charging nest 200 further includes at least one signal generator 215 and at least one RF power amplifier 220 electrically coupled to the plurality of antennas 210. In addition, the charging nest 200 includes at least one sensor 225 electrically coupled to the at least one signal generator 215. The at least one sensor 225 is configured to detect a device-for-charging (“DFC”) 230 and a location associated with a receiver 235 coupled to the DFC 230 and to communicate the location to the signal generator 215 to facilitate beam-steering. In operation, the DFC 230 may reside inside of or in proximity to the charging nest 200 to receive a charge.

In one optional implementation, the plurality of antennas 210 are single-loop antennas, dipole antennas, TCDAs, slot antennas, dipole antennas, Yagi-Uda antennas, Bessel beam launcher-type antennas, leaky-wave antennas, antennas/arrays generating OAM waves (like spiral and helical antennas), metasurfaces, transmit-arrays, reflect-arrays, and/or reflective intelligent surfaces, for example. In an alternative implementation, the plurality of antennas 210 are each a spherical antenna array 310 described below with respect to the third aspect of the disclosure. In one optional implementation, the plurality of antennas 210 are spaced equidistant from each other about the periphery 206 of the housing 205.

In one optional implementation, shown in FIG. 16, the charging nest 200 includes a primary single-loop antenna 211 circumscribed by the plurality of antennas 210. In a further optional implementation, shown in FIG. 16, the primary single-loop antenna 211 has an aperture arranged in a vertical direction and the plurality of antennas 210 have apertures arranged in different directions. In another optional implementation, the plurality of antennas 210 are single-loop antennas and have the same diameter. The primary single-loop antenna 211 also has a larger diameter than each of the plurality of antennas 210.

In one optional implementation, as shown in FIG. 12, the charging nest 200 further includes a plurality of repeaters 240 coupled to the housing 200 that receive signals from the plurality of antennas 210 and that retransmit the signals to at least one DFC 230.

In one optional implementation, as shown in FIG. 12, the charging nest 200 also includes a plurality of receivers or transceivers 245 electrically coupled to the at least one signal generator 215 such that the plurality of receivers or transceivers 245 harvest signals from ambient microwaves in a surrounding environment to facilitate power generation and charging.

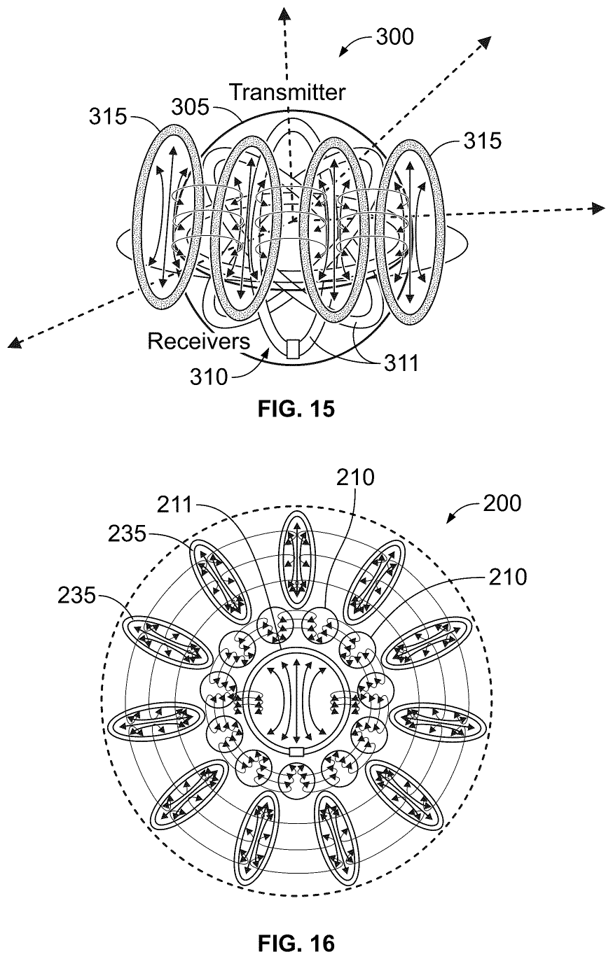

In a third aspect of the disclosure, shown in FIGS. 13-15, a charging nest 300 for wireless charging includes a housing 305 and at least one spherical antenna array 310 arranged within the housing 305. The spherical antenna array 310 includes a plurality of antennas 311 arranged at an angle α relative to each other such that the at least one spherical antenna array 310 provides elevational charging (shown in FIG. 14) and azimuthal charging (shown in FIG. 15). The combination of elevational and azimuthal charging results in diagonal charging aided by the juxtaposition of both electric and magnetic fields (i.e., mixed coupling). FIGS. 14 and 15 depict receivers 315 corresponding to the DFCs.

In one optional implementation, the plurality of antennas 311 are single-loop antennas, slot antennas, dipole antennas, and/or Yagi-Uda antennas, for example.

In one optional implementation, the housing 305 is circular or ring-shaped (e.g., FIGS. 11-12). In this implementation, the at least one spherical antenna array 310 includes a plurality of spherical antenna arrays 310 arranged about the periphery of the housing similar to the arrangement in FIGS. 11-12. In one optional implementation, the plurality of spherical antenna arrays 310 includes a spherical antenna array 310 arranged in the center of the housing.

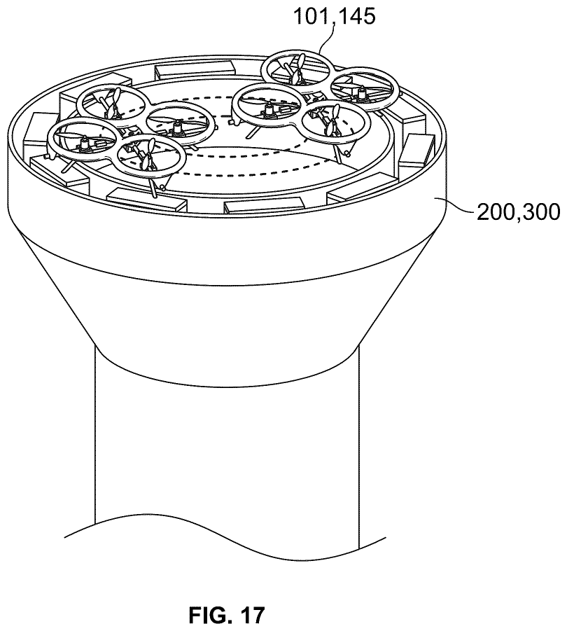

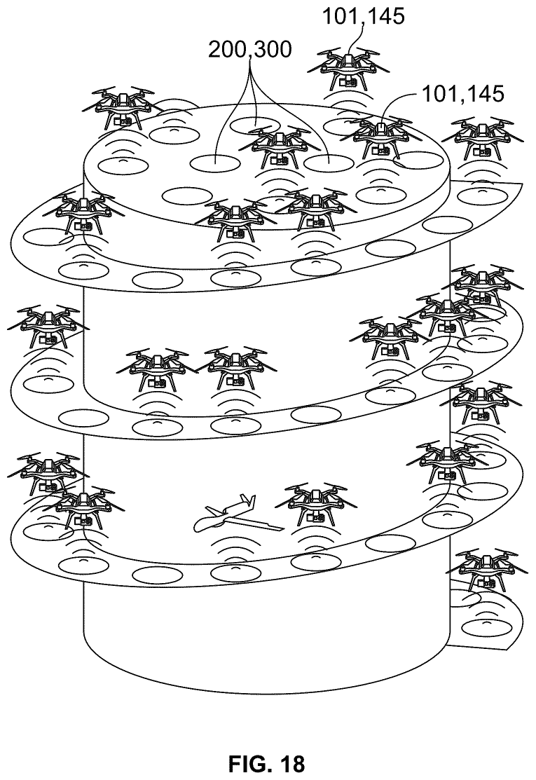

In various embodiments, the charging nests 200 and 300 according to the second and third aspects of the disclosure may be arranged at the top of a tower (FIG. 17), atop skyscrapers or houses, embedded in pavement throughout a spiral parking lot (FIG. 18), in mobile charging hubs for large crowd events, or embedded in building walls or in furniture, for example.

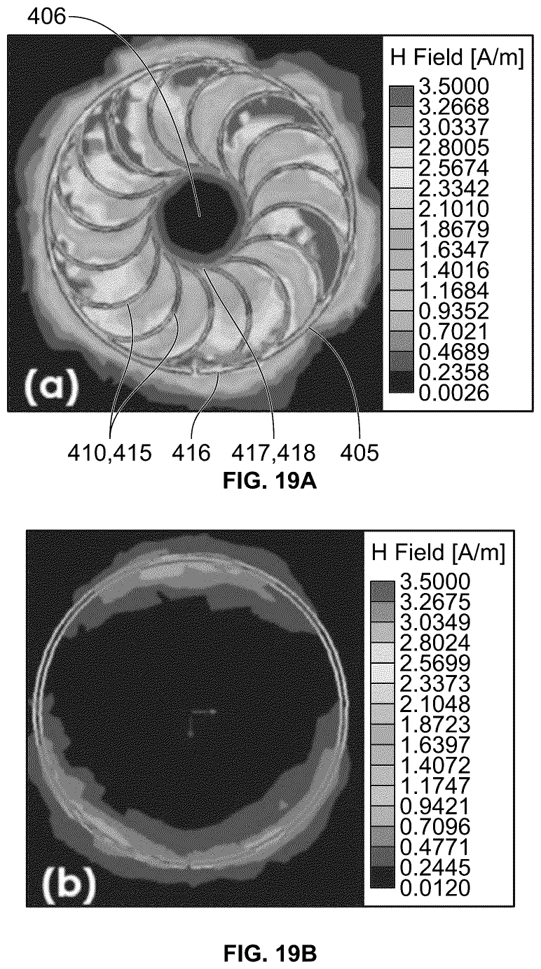

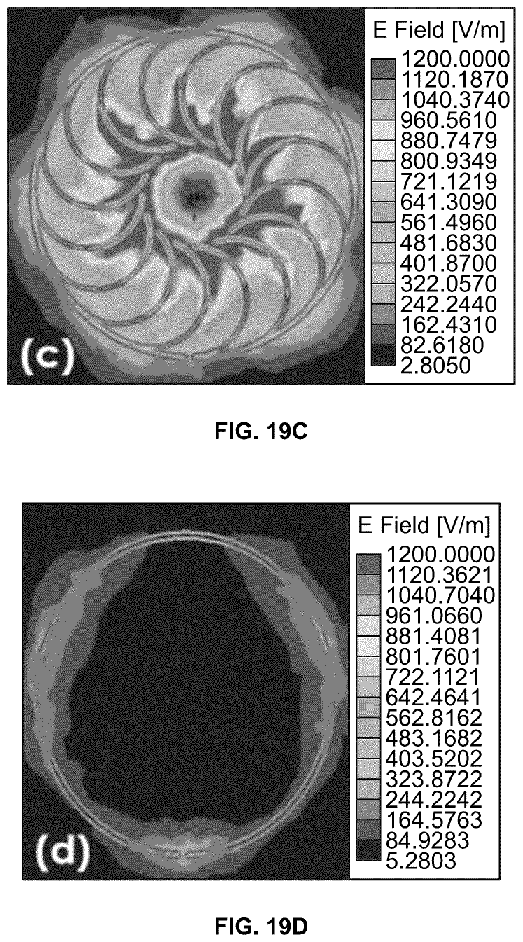

In a fourth aspect of the disclosure, shown in FIGS. 19A-24C, a resonator 400 for wireless power transfer and harvesting includes a single-loop resonator 405 coupled to a plurality of semi-circular resonators 410 evenly spaced about a periphery of the single-loop resonator 405 thereby concentrating electric and magnetic fields in a center of the single-loop resonator 405 and/or along the periphery of the single-loop resonator 405. The resonator 400 can be built on any type of substrate (e.g., rigid, flexible, or textile-based). In operation, magnetic and electric fringing fields from the plurality of semi-circular resonators 410 strengthen the magnetic field of the single-loop resonator 405.

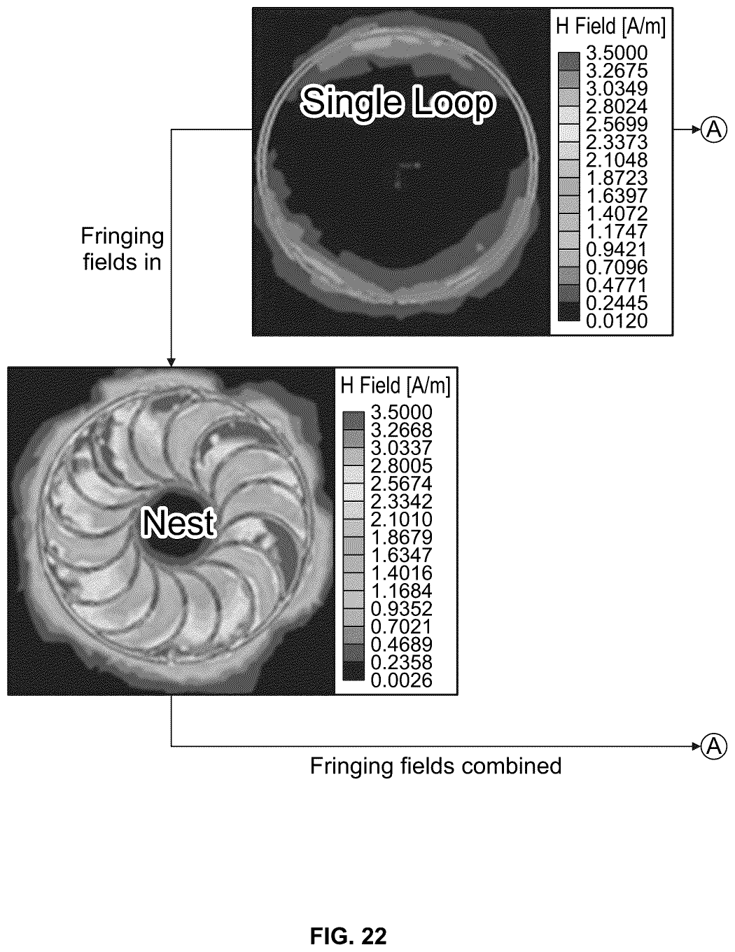

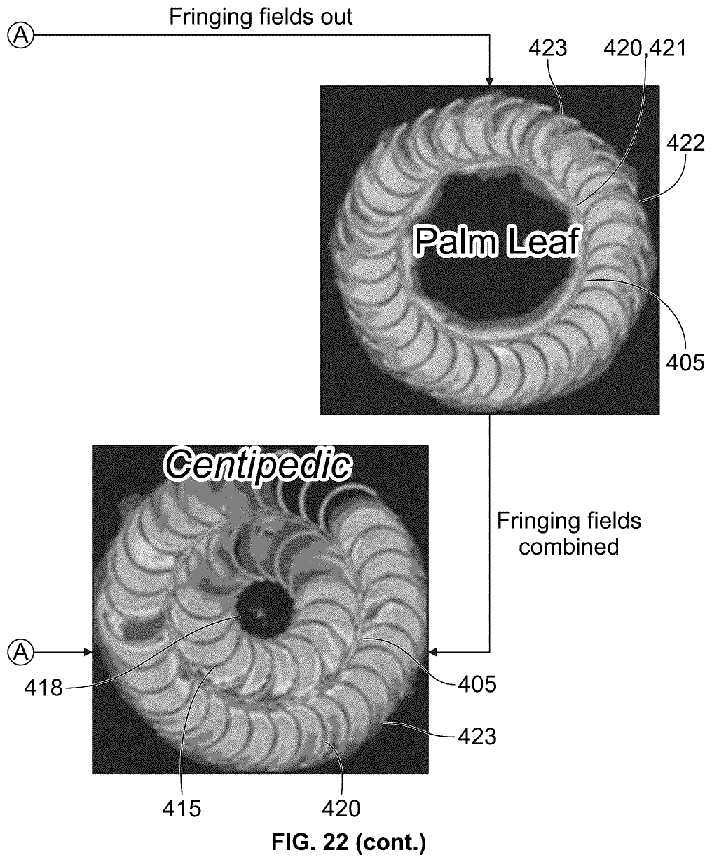

In one optional implementation, shown in FIGS. 19A, 19C, and 22, the plurality of semi-circular resonators 410 includes a first set of semi-circular resonators 415 that each have a first end 416 coupled to an interior of the single-loop resonator 405 and a second end 417 arranged in an interior 406 of the single-loop resonator 405 such that a second loop 418 is formed in the interior of the single-loop resonator 405.

In one optional implementation, shown in FIG. 22, the plurality of semi-circular resonators includes a second set of semi-circular resonators 420 that each have a first end 421 coupled to an exterior side of the single-loop resonator 405 and a second end 422 extending radially outward from the single-loop resonator 405 such that a second loop 423 is formed around the exterior of the single-loop resonator 405.

In one optional implementation, the second ends 417, 422 of the first set 415 and of the second set 420 of semi-circular resonators are arranged immediately adjacent to each other.

### Example 2: A Novel Clothing-Based Nest-Inspired Resonator for Wireless Power Transfer and Harvesting

A new topology for textile-based wireless power transfer and harvesting system is presented. This system consists of a nest-inspired resonator that concentrates the electric and magnetic fields in the center and within the periphery of the nest, respectively for robust electromagnetic field presence to tackle the misalignment problem with wireless charging. The resonator was designed and simulated to operate at 433 MHz. This design enabled high power transfer efficiency (“PTE”) when the resonator was under the influence of lateral misalignment along the direction of the RF current. The results suggest a PTE of up to 82.5% within 10 cm of displacement. This is 10% improvement over the PTE of a single loop operating at the same frequency. The diagonal misalignment showed a PTE of up to 77.5% within 10 cm of misalignment. This is up to a 20% improvement over that of the single loop. A textile-based power harvesting circuit operating at 433 MHz with an RF-to-DC conversion efficiency of 82% at 500 mW is proposed to be integrated with the resonator. A combination of the resonator and power harvesting circuit will be implemented on an ad-hoc, on-body charging platform to power body-worn sensors.

### I. Introduction

Designing a misalignment-free wireless power transfer system has been the focus of various research projects especially for wearable systems. The wearer of the wearable structures will be subject to all types of misalignment during their daily activities. The first on-clothing misalignment-insensitive wireless power transfer and harvesting featured an anchor-shaped antenna. This antenna exploits the electric and magnetic fringing fields emanated from two discontinuities carved on two opposite sides of the single loop and a central bar to locate a strong magnetic field, respectively. This design allowed for a PTE of up to 80% for lateral and angular misalignment even when the anchor-shaped antenna was subject to mechanical deformations. The concept of mixed coupling corresponding to the superposition of electric and magnetic coupling has also been investigated. For example, magnetic coupling (k_{M}) was used to achieve high PTE for lateral misalignment along the direction of the RF current and electric coupling (k_{E}) for high PTE when lateral misalignment across the cavities was considered. However, a PTE for misalignment in the diagonal direction (superposition of the direction of the RF current and across the cavity) was not reported. The disclosed resonator uses a new topology, “nest-like” to exploit the superposition of k_{E} and k_{M} for high PTE for diagonal misalignment, angular misalignment, and lateral misalignment. That is, when the transmitting (Tx) and receiving (Rx) resonators are misaligned in the direction parallel to that of the RF current, a PTE of up to 82.5% was achieved. When the pair (Tx, Rx) was subject to diagonal misalignment, 20% of improvement was achieved when compared against that of a single loop operating at the same frequency. A rectifying circuit operating at the same frequency was designed and simulated. The peak RF-to-DC conversion efficiency at 500 mW was found to be 82%, and a voltage level of 11 V was collected. Combining the resonator and rectifying circuit together on clothing, it can be used for on-demand clothing-based wireless charging.

### II. Textile Antenna: Design and Simulation

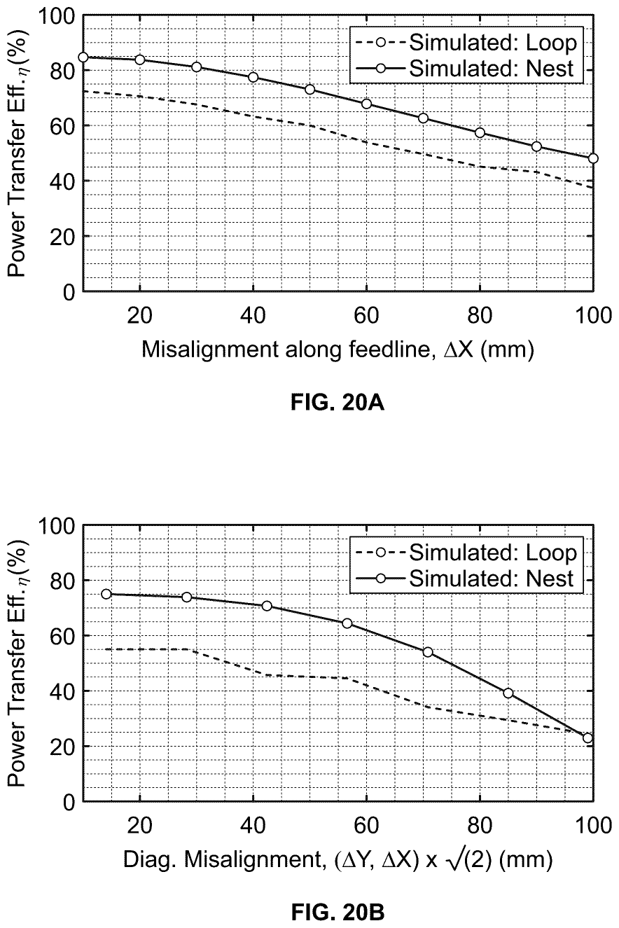

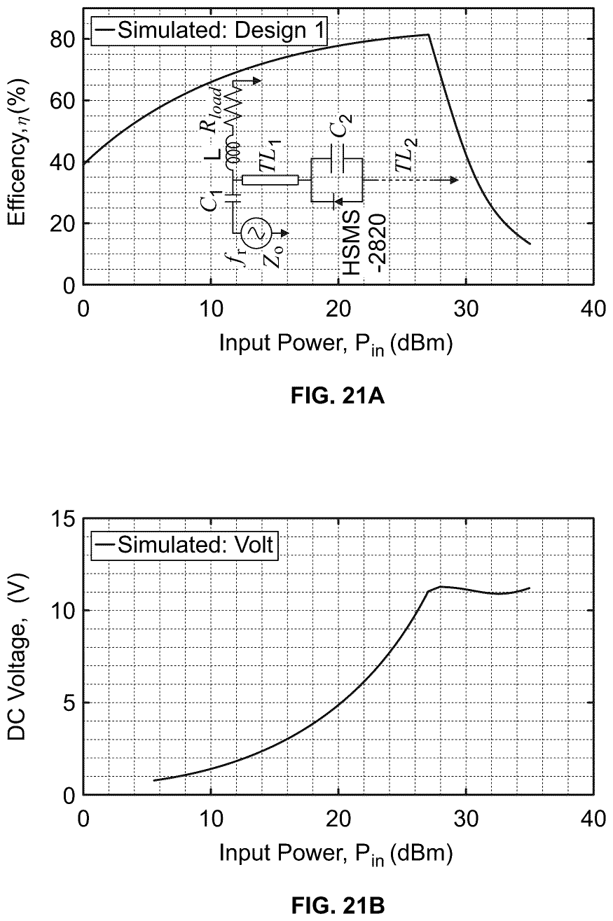

The disclosed nest-inspired resonator operating at 433 MHz is depicted in FIGS. 19A and 19C. The design is realized by introducing fringe-enabling semi-circles to a single loop resonator of the same length in order to localize the electric and magnetic field within the conductive surface of the resonator for strong proximity couplings. As can be seen from FIGS. 19A-D, the electric and magnetic fields emanated from the proposed resonator are much stronger than those of a single loop considering the same resonant frequency. As a result, the superposition of the electric and magnetic couplings for the disclosed resonator will yield a better power transfer efficiency. The aforementioned statement is supported by the simulation results depicted in FIGS. 20A-B, where an improvement of 10% is achieved over the performance of a single loop for a lateral misalignment in the direction of the feed-line of up to 10 cm. In addition, an improvement of up to 20% over the performance of a single loop resonator when diagonal misalignment is considered for up to 10 cm. Following these results, it is expected that the lateral misalignment in the direction perpendicular to the feed-line should yield a high PTE as well as those when the influence of the angular misalignment scenarios (elevational and azimuthal) are considered. Performance of the power harvesting circuit is shown in FIGS. 21A-B.

### III. Textile Rectifying Circuit: Design and Simulation

Given the high-PTE performance of the resonator, there is an opportunity for harvesting the received power that can be used to power body-worn circuits. This design is a further simplification of devices known in the art demonstrating an improvement of 2 dB is achieved for the 70% power bandwidth for RF-to-DC conversion efficiency, 5 dB more than another known device, and the same as a further known device. The 80% power bandwidth for RF-to-DC conversion efficiency was found to be 5 dB. A peak RF-to-DC conversion efficiency was found to be 82% at 0.5 W. For a transmitting RF power of 1 W from the transmitter and at 10 cm of lateral and diagonal misalignment, DC power will be 400 mW and 160 mW, respectively. These power levels are enough to power a wide range of body-worn sensors. Therefore, the integration of the nest-inspired resonator and a corresponding rectifying circuit will be able to harvest enough power to drive a wide range of wearable electronics for IoT/Io MT applications.

### IV. Conclusion

A novel misalignment-free resonating system is disclosed herein and designed and simulated using a “nest-inspired” topology for high-efficiency wireless power transfer that can be combined with a rectifying circuit on clothing for smart electronics and sensing. The results suggest that this type of resonator topology allows for a PTE of up to 82%, when displacements are considered in directions parallel to that of the RF current, and 20% improvement in PTE for diagonal displacement when compared to that of a single loop operating at the same frequency. This textile resonator can also be combined with a textile rectifying circuit yielding 82% RF-to-DC conversion efficiency at 500 mW to be used to power on-body electronics. This design can help in eliminating the use of a battery pack used for ad hoc on-body charging.

### Example 3: A Biomimetic Resonator for Fabric-Based Wireless Power Transfer, Harvesting, and Charging of Sensors and Internet of Medical Things

A biomimetic resonator topology is disclosed that is designed for the development of electromagnetics-on-clothing (“EoC”) or electromagnetics-on-fabrics (“EoF”), enabling the powering and charging of sensors and Internet of Medical Things (“IoMT”) devices. The disclosed topology achieves full flexibility, low cost, low-profile design, and bio-compatibility by combining structures with spanned-in and spanned-out magnetic fringing fields in a centipedic configuration to address the challenges of misalignment in near-field power transfer. This configuration allows for the formation of a cluster of strong magnetic fields on both sides of a single-loop resonator. When the magnetic fields are spanned out, the topology demonstrates a wireless power transfer efficiency (“WPTE”) of up to 80% for lateral and diagonal misalignment distances ranging from 1 cm to 10 cm. This achievement represents an improvement of up to 30% and 50% over its spanned-in and single-loop counterparts, respectively, for lateral misalignment. Moreover, this disclosed resonator shows a WPTE improvement of up to 30% compared to both counterparts for diagonal misalignment. The performance of the proposed resonator was compared to state-of-the-art textile resonators and found to be comparable or even superior. The fully-flexible, low-cost, bio-compatible, and low-profile characteristics of the disclosed resonator make it highly appealing for wearable EoF applications. By combining the proposed resonator with a power harvesting circuit, a near-field EoF for sensors and IoMT devices can be realized.

The concept of Electromagnetics-on-clothing (“EoC”), Electromagnetics-on-fabrics (“EoF”), and Electromagnetics-on-textiles (“EoT”) hubs, which are structures implemented on clothing to provide wireless power transfer and harvesting capabilities for various IoT and wearable applications. These hubs are designed to address the increasing demand for smart wearable technology, enabling connectivity among billions of devices and ensuring continuous power supply. As wearable devices are meant to be worn on the body, implementing charging and power structures on clothing is an ideal solution.

The market for wearables has been experiencing exponential growth, with predictions indicating revenue exceeding EUR 120 billion and the supply of over 5 billion units by 2026. To meet these predictions, researchers in wearable technology need to focus on developing standalone systems that are self-powered and offer independence to users, regardless of whether the wearable structures are on-body, in-body, or off-body. Previous works have explored the implementation of EoC/EoF/EoT hubs using conductive threads embroidered onto fabric substrates. For example, a far-field EoF system was proposed in 2020, utilizing a 2×3 antenna array operating at 2.45 GHz and harvesting circuits with an RF-to-DC efficiency of 70%. This system achieved a DC power level of 0.6 mW, sufficient for powering a range of biosensors. However, the limited power collection may restrict the range of sensor applications, as some sensors require slightly over 1 mW.

One crucial criterion for wearable technology is the ability to provide hassle-free charging and power supply, enabling timely decision-making by the wearer. Regardless of the wearer's location, the device should constantly charge and process information. However, when the wearer is far from a Wi-Fi router, the power received by the device decreases, potentially interrupting the decision-making process. In such scenarios, an array of EoFs operating in the near-field would be an ideal solution. Alternatively, a near-field EoF resilient to misalignment can ensure uninterrupted charging, regardless of the wearer's movement or location. Misalignment has been a topic of research, with solutions including strongly coupled resonant structures using intermediate helical structures or multiple parasitic elements to achieve high wireless power transfer efficiencies (“WPTEs”).

The most recent development involved a planar, strongly coupled resonant structure, implemented in textile to tackle misalignment challenges. This system achieved a WPTE of up to 80% at a distance of 60 mm and 80 MHz. However, it was not demonstrated for power transfer in a setting that emulates multiple charging points within a landscape. To address this challenge, a near-field EoF with a misalignment-resilient resonator was published in 2021. This implementation involved integrating a textile-anchor shaped antenna into clothing and upholstery, enabling the collection of 10 mW of DC power in a room-sized setting. The resonator operated at a frequency of 360 MHz and achieved a WPTE of up to 80% by utilizing fringing fields to strengthen the existing electric and magnetic fields. This complete near-field EoF provided ergonomic charging for fitness trackers, bio-electrochemical sensors, location trackers, accelerometers, and other body-worn sensors. However, there is still a need for additional EoFs for various applications.

Recently, a near-field EoF was developed to address misalignment in the diagonal displacement. The diagonal displacement combines vertical and horizontal displacements. This EoF utilized a nest-inspired resonator, offering approximately 20% better WPTE compared to a single-loop resonator at an operating frequency of 433 MHz. By combining an 82% RF-to-DC conversion rectifying circuit with the nest-like resonator, it was predicted to achieve a DC power collection of 500 mW within a 10 cm diagonal separation. Integrating this nest-like resonator and rectifier onto clothing would create an excellent near-field EoF, serving as an ad-hoc, on-body charging platform for body-worn sensors.

A different topology called the palm tree leaf is disclosed. This topology utilizes fringe-enabling demi-loops to enable high WPTE in both lateral and diagonal directions. Additionally, an integral topology combining the effects of the palm-tree-leaf and nest-inspired topologies is introduced, forming a biomimetic centipedic resonator.

The design incorporates demi-loops placed inside the loop antenna to strengthen the existing magnetic fields by trapping them, mimicking the way centipedes capture prey. This design, referred to as the “nest-inspired” resonator, distributes magnetic fields throughout the inner surface of the loop, resulting in an expected higher wireless power transfer efficiency (“WPTE”) compared to a single loop. Additionally, fringe-enabling demi-loops were strategically placed in a flared-out or “spanned-out” shape resembling a palm tree leaf. The purpose was to expand the magnetic fields' coverage area when combined with the nest-like resonator. FIG. 22 illustrates the spanned-out magnetic fields, appearing stronger than the single-loop counterpart at various distances.

The study focuses on linear misalignment types, including movement along the feedline, across the feedline, and in the diagonal direction. Previous methods to maintain a misalignment-resilient WPTE had limitations in terms of high efficiency and simplicity of planar and clothing-integratable structures. This research addresses these concerns by proposing a simple, planar, fully flexible, and clothing-integratable resonator topology that enables misalignment-resilient wireless power transfer.

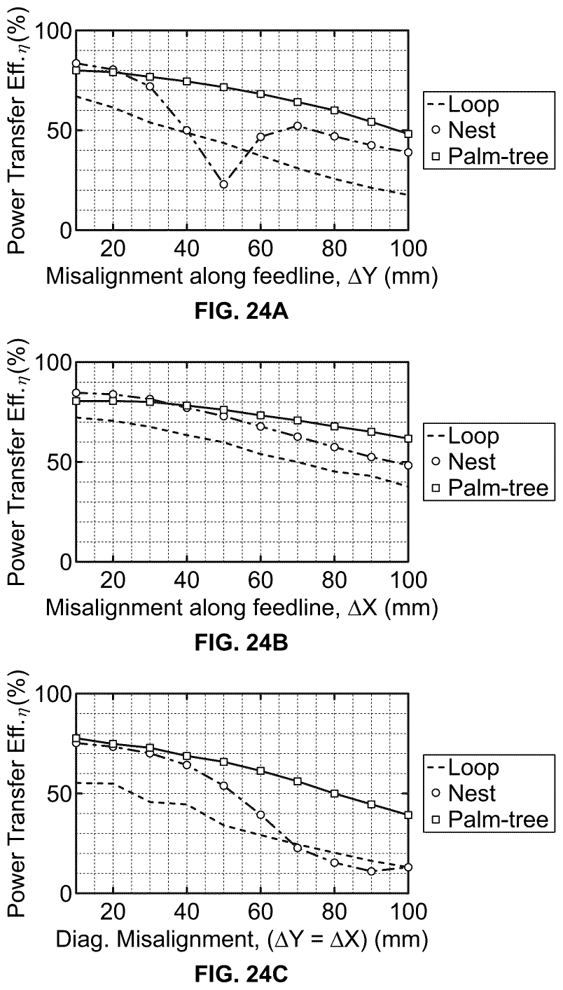

FIGS. 24A-C present the WPTE characterization of the single-loop, nest-inspired, and palm-tree-leaf resonators using the provided equation. The WPTE values were calculated for different misalignment types (X-move, Y-move, and diag-move) with distances ranging from 1 cm to 10 cm between the transmitter (Tx) and receiver (Rx). The palm-tree-leaf resonator demonstrated a WPTE ranging from 50% to 80% under Y-move misalignment, with a significant improvement of up to 30% over the single-loop resonator and 50% over the nest-inspired resonator. The nest-inspired resonator's performance showed some deterioration near 5 cm, indicating potential radiative effects requiring further investigation.

Under X-move misalignment, the palm-tree-leaf resonator achieved a WPTE range of 60% to 80% and exhibited improvements of up to 20% and 10% compared to the single-loop and nest-like resonators, respectively. Similarly, for diag-move misalignment, the palm-tree-leaf resonator displayed up to 30% WPTE improvement over both the nest-like and single-loop counterparts in both X- and Y-directions for distances up to 10 cm.

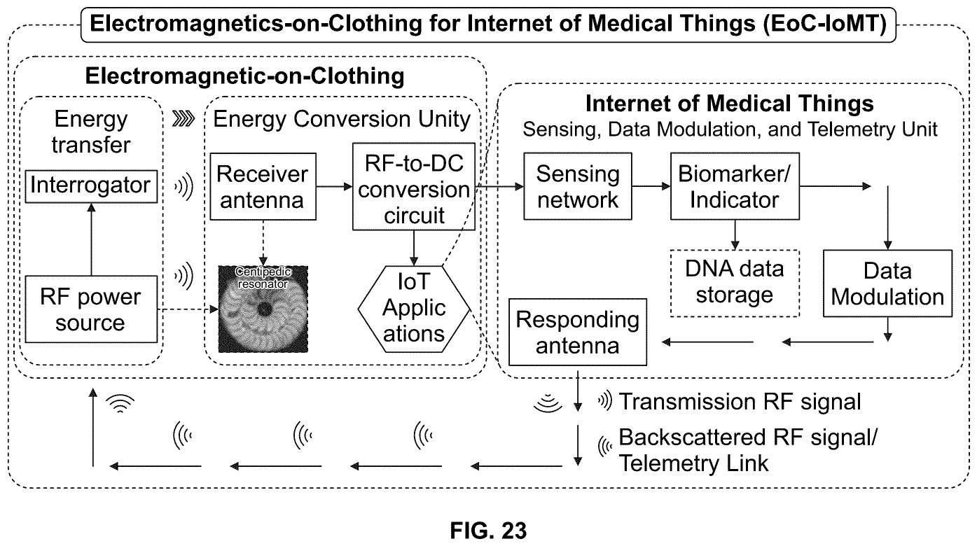

The palm-tree-leaf resonator's implementation in fabric materials enables EoF integration (as shown in FIG. 23). When combined with a rectifying circuit implemented on clothing, this topology becomes scalable and suitable for various smart wearable applications. The disclosed resonator demonstrated similar or better performance than other known devices. The key features that distinguish the proposed resonator include the simple planar configuration, integration with clothing (flexible, low-cost, bio-compatible, washable, and reliable), scalability, and versatility for EoF integration in charging platforms for IoT and sensor applications.

In conclusion, the disclosed nest-like resonator presents a full-wave simulation of a novel centipedic resonator topology that concentrates strong magnetic fringing fields near the single-loop aperture, addressing misalignment challenges in near-field wireless power transfer. This example observes the effects of lateral and diagonal misalignments and demonstrates a WPTE of up to 80% for a misalignment distance of 10 cm. Compared to the spanned-in and single-loop topologies, the centipedic resonator shows WPTE improvements of up to 50% and 30%, respectively. Furthermore, the proposed resonator outperforms existing textile-based resonators and offers wearability and integration capabilities for power harvesting in wireless charging hubs and smart wearable devices for medical applications.

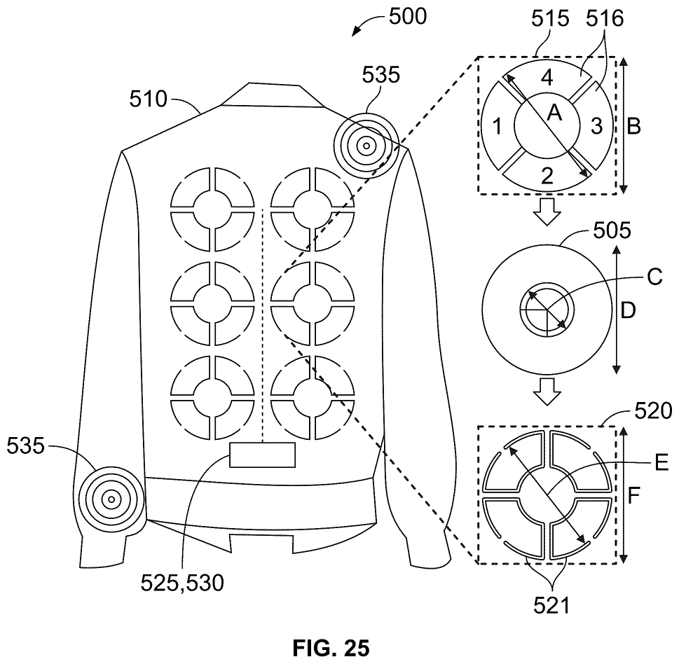

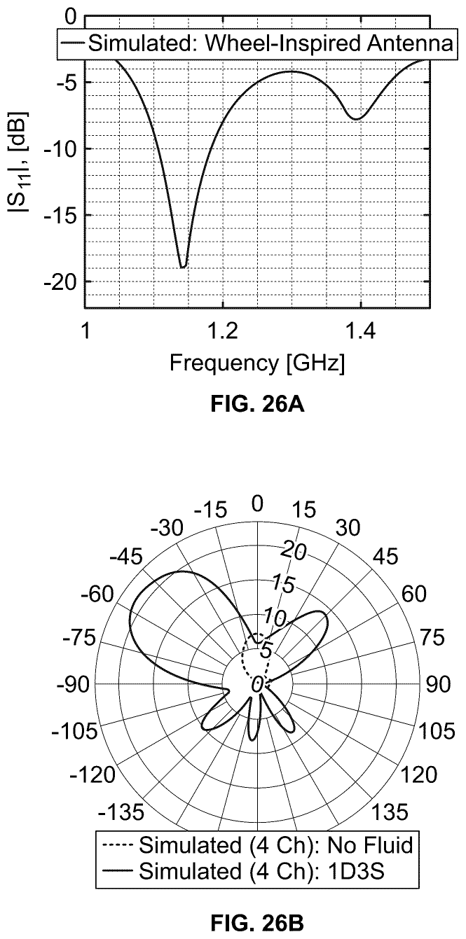

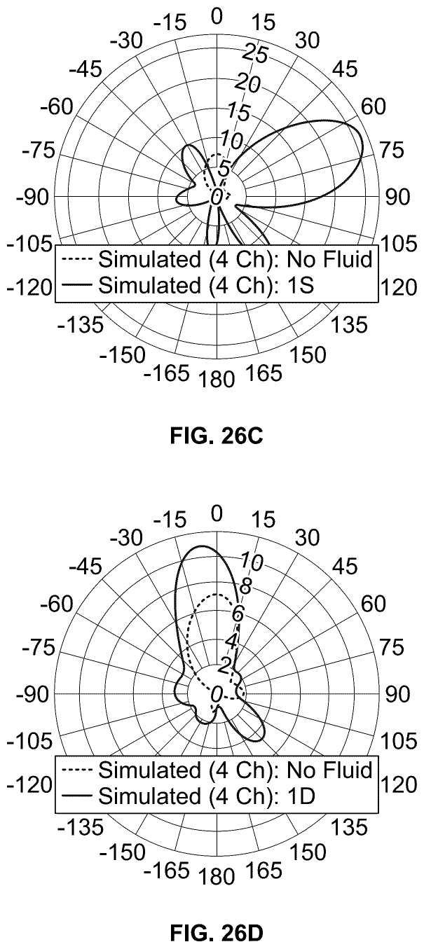

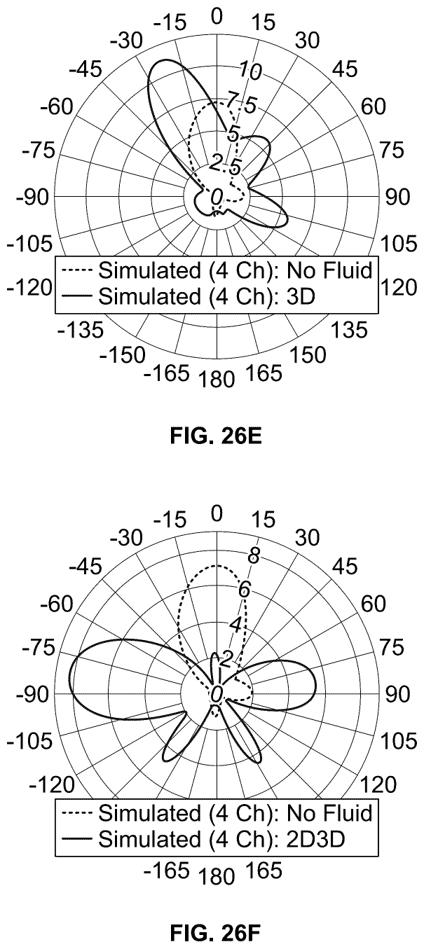

In a fifth aspect of the disclosure, shown in FIGS. 25-26F, a wearable antenna array 500 includes a plurality of resonators 505 according to the fourth aspect coupled to a textile 510. The wearable antenna array 500 also includes a plurality of fluid-based actuators 515 (i.e., “the fluidic channel”) each coupled to a first side of one of the plurality of resonators 505 (i.e., “the feeding source” or “RF feed”). Each fluid-based actuator 515 includes a multi-channel platform having at least four channels 516 each formed from a compartment made of polymer that each contains a fluid. The wearable antenna array 500 further includes a plurality of radiators 520 each coupled to one of the plurality of fluid-based actuators 515 and to one of the plurality of resonators 505. Each radiator 520 includes a multi-compartment loop 521.

In one optional implementation, the wearable antenna array 500 further includes a plurality of ground planes each coupled to a second side of one of the plurality of resonators thereby providing a radiation shield. Further, antennas worn by humans to operate in media of up to 50 Watts (with SARs complying to FCC regulations) are currently thought to be safe for a wearer thereof.

In one optional implementation, each of the plurality of resonators 505 is circumscribed by one of the plurality of radiators 520.

In one optional implementation, the wearable antenna array 500 further includes a plurality of transceivers each electrically coupled to one of the plurality of resonators 505. The wearable antenna array 500 may have the ability to capture more power as the beams focus on directions where power is coming from regardless of their phases.

In one optional implementation, the wearable antenna array 500 further includes a rectifying circuit 525 coupled to each of the plurality of resonators 505. The rectifying circuit 525 converts RF signals received by the plurality of transceivers to DC power.

In one optional implementation, the wearable antenna array 500 also includes a DC power combiner 530 electrically coupled to the rectifying circuit 525.

In one optional implementation, the wearable antenna array 500 further includes at least one sensor 535 coupled to the textile 510 and electrically coupled to the DC power combiner 530. The power combiner 530 may be used to power the body-worn sensors 535. In one optional implementation, textile 510 corresponds to a smart bandage with fluid-activated/actuated reconfigurable antennas used as smart RF sensors for rapid diagnosis. These sensors may include a pH sensor, temperature sensor, lactate sensors, oxygen sensor, uric acid sensor, or any other sensor required for a given application. In one implementation, the sensor can be tuned to generate an alert signal when a characteristic or level of charging or of a fluid or other characteristic of a sensor exceeds a set level. A remote receiver (phone) may capture signals pertaining to wound health (recovery, infection, relapse) to be sent to a medical professional. In a further implementation, a smart health system may include misalignment-free smart charging antennas, smart health devices (IoMT devices), remote receivers (scanners), and telemetry (real-time communication with doctors), and smart storage of health information (AP servers).

In one optional implementation, a wireless power transfer and data telemetry system using slot Yagi-Uda antennas at a medical center or Kiosk is contemplated. The near-field interrogators are embedded in the walls and the ceiling. Slot Yagi-Udas may also be embedded into a smart shirt and bandage worn by the person walking in the hallway. The slot Yagi-Udas embedded in the shirt and bandage are integrated with harvesting and sensing modalities for smart, personalized, and connected health where data telemetry links are established with the near-field interrogators where the health-data will be sent to and be transferred to caregivers (medical personnel) for health assessment.

In one optional implementation, the fluid in the fluid-based actuator 515 may be any non-toxic fluid, including but not limited to distilled water or salt water.

In one optional implementation, the plurality of transceivers are configured to receive RF signals from the charging nest 200, 300 according to the second aspect or the third aspect of the disclosure. These charging nests can be built into the walls, ceiling, and/or floors of a building to facilitate charging and information transfer.

In a further implementation, an energy-harvesting vest may be worn over the underlying textile 510 in the form of a jacket and the vest may be an array of phase-shifters for ad hoc beam steering. The underlying textile 510 may be used as the base platform for wireless power transfer and harvesting.

### Example 5: A Novel Fluid-Based Pattern-Reconfigurable, Textile Antenna Array for Wearable Applications

This example focuses on the ability to change the pattern of a textile antenna by using fluidic selection in a 4-channel platform that serves as both parasitic and phase shifters. A loop antenna was created using conductive textile automatically embroidered onto denim fabric. The 4-channel platform was placed on top of the antenna to function as a flat lens and a beam-steering engine. Two types of fluids, distilled water and sea water, were chosen as actuators. Each channel was activated separately using one fluid at a time, and the resulting radiation was assessed. The simulation results indicate that at 1 GHz, by utilizing distilled water and sea water, the antenna's elevation angle can be steered from −145 degrees to 139 degrees, while the amplitude of the achieved gain ranges from 1 to 15 dB. This is the first documented study of a fluidically reconfigurable antenna integrated into clothing.

### I. Introduction

As 5G/6G technology becomes more prevalent, the demand for wearable devices is expected to skyrocket. Consequently, the need for these devices to operate without batteries will be essential. These devices will find applications on the Internet of Everything (“IoE”) and Internet of Medical Things (“IoMT”). In both scenarios, users will require continuous charging for extended periods, depending on their daily activities. Therefore, an ergonomic approach is necessary to provide users with on-demand power to charge their devices.

The widespread deployment of 5G/6G technology will enable the presence of base stations (“BSs”) in various locations, both terrestrial and aerial. These BSs will transmit RF power at different frequencies, creating ultra-dense networks. This abundant power will not be fully utilized by users, resulting in a portion being dispersed in the environment and available for harvesting. Consequently, there will be a need to deploy numerous energy harvesting devices (“EHDs”) capable of capturing and converting this available power into usable energy for IoT/IoMT devices. To maximize the harvesting of RF signals originating from different directions, the EHDs must be equipped with beam-steering antennas. These antennas can employ fluid-based actuators as beam-steering modules.

Several studies have explored the use of fluidics, such as liquid metal (LM), to achieve pattern and frequency reconfiguration in antennas. These reconfigurations have allowed for the switch between linear and circular polarization, as well as 360-degree beam steering with a frequency range of 0.89 GHz to 1.63 GHz. However, these antennas were limited to rigid PCB substrates, preventing their integration into clothing.

To address these limitations, a fabric-based antenna is disclosed that incorporates fluid-based actuators for beam steering. Fluid-based actuators offer several advantages: they are environmentally friendly, cost-effective, non-hazardous, and easily accessible. With these benefits in mind, a beam-steerable antenna array is disclosed using distilled and salt water as actuating fluids, enabling reconfigurability across the entire elevation plane.

The disclosed antenna array aims to achieve wireless power transfer and harvesting of ambient RF signals. Operating at 1 GHz, the antenna demonstrates a gain of 7.13 dB when no fluidic channel is actuated. The beam steering functionality is achieved through the activation of four fluidic channels using distilled and salt water, allowing the beam to be steered from −145 degrees to 139 degrees in the elevation plane. Additionally, the amplitude of the beam is enhanced from 6.5 dB to 15 dB.

The disclosed antenna array offers several appealing features, including its low-profile topology, textile-based nature, affordability, and convenience for integration into garments. These characteristics make it a promising choice for 5G/6G wearable devices.

### II. Antenna Design and Performance

The antenna design is illustrated in FIG. 25 and includes three components: (1) a fluidic channel, represented by a low-dielectric polymer cavity to house the fluidics, (2) the radiator, which takes the form of a 4-compartment wheel-inspired loop, and (3) the feeding source, a small loop that illuminates the radiator for beam steering. The electromagnetic coupling scheme employed is proximity coupling. To shield the bearer from potential radiation, a ground plane is situated 58 mm (λ_{g}/4) below the feeding source.

The radiator, feeding ring, and ground plane are designed as conductive traces, mimicking embroidered surfaces of Elektrisola-7 threads on gauze fabric and a stabilizer with a dielectric constant ϵ=1.67, a thickness of 1.5 mm, and a loss tangent tan δ=0.07. Four channels are incorporated and positioned above the radiator to facilitate beam steering and enhance its amplitude.

A full-wave simulation of the model is conducted using Ansys/HFSS. The antenna's performance without fluid actuation is compared to its performance with fluid actuation using distilled water, salt water, or both. FIGS. 26A-F depicts the simulated results of the reflection coefficient and realized gain of the antenna. The antenna resonates at 1.14 GHz, with a corresponding |S₁₁| value of −19 dB and a realized gain of 7.13 dB. In FIGS. 26B-F, the following scenarios are shown: FIG. 26B when channels 1 and 3 are actuated by distilled water and salt water respectively, the gain amplitude improves from 7.13 dB to 13.22 dB, and the phase changes from 0° to 67.5°; FIG. 26C when channel 1 is actuated by salt water; FIG. 26D when channel 1 is actuated by distilled water, resulting in a 3 dB gain improvement and a phase change from 0° to 8°: FIG. 26E when channel 3 is actuated by distilled water, leading to a 3.3 dB gain improvement and a phase shift from 0° to −28°; and FIG. 26F when channels 2 and 3 are both actuated by distilled water, the gain improves by 1.5 dB and the steering angle shifts from 0° to −82.5°. The gain enhancement is attributed to the water-based channel acting as a superstrate with ϵ_{water}.

### III. Conclusion

The disclosed textile-based antenna array has beam steering and amplitude enhancement capabilities. The antenna topology is a proximity-fed wheel-inspired loop, and beam reconfiguration is achieved through a 4-channel system filled with distilled water and salt water. The simulation results indicate that when using distilled water and salt water as actuators, the gain amplitude ranges from 1 to 15 dB, and the phase shifts from −145° to 139° in the elevation radiation plane. As the antenna is realized on textile for the first time, it can serve as a valuable design reference for future pattern-reconfigurable antennas in wearable technology during the 5G/6G era.

The description of different advantageous arrangements has been presented for purposes of illustration and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to best explain the principles of the examples, the practical application, and to enable others of ordinary skill in the art to understand the disclosure for various examples with various modifications as are suited to the particular use contemplated.

1. A charging nest for wireless power transfer to drones, comprising:
a housing having an opening at a first end;
a plurality of antennas arranged around a periphery of the housing with each antenna aperture arranged facing a center of the housing, wherein each of the plurality of antennas has a director, an exciter, and a plurality of reflectors; and
a plurality of transmitters or transceivers each electrically coupled to a corresponding exciter of the plurality of antennas.

2. The charging nest according to claim 1, wherein each of the plurality of antennas is a Yagi-Uda antenna.

3. The charging nest according to claim 1, wherein the housing is cylindrical, and the plurality of antennas are arranged in a circular array.

4. The charging nest according to claim 1, wherein the plurality of reflectors for each of the plurality of antennas comprises at least nine reflectors.

5. The charging nest according to claim 1, wherein the plurality of reflectors for each of the plurality of antennas are arranged in a semi-circle relative to the exciter.

6. The charging nest according to claim 5, wherein the plurality of reflectors for each of the plurality of antennas comprise a main reflector aligned with the exciter and a plurality of auxiliary reflectors evenly distributed on either side of the main reflector along the semi-circle.

7. The charging nest according to claim 5, wherein the circular array of the plurality of antennas extends along a length of the housing.

8. The charging nest according to claim 1, wherein a second end of the housing is sealed.

9. The charging nest according to claim 1, wherein the first end and the second end of the housing are hemispherical.

10. The charging nest according to claim 1, further comprising:
at least one platform arranged in the center of the housing and coupled to an interior wall of the housing.

11. The charging nest according to claim 1, further comprising:
at least one signal generator and at least one RF power amplifier electrically coupled to the plurality of antennas; and
at least one sensor electrically coupled to the at least one signal generator, wherein the at least one sensor is configured to detect a device-for-charging (“DFC”) within the housing and a location associated with a receiver coupled to the DFC and to communicate the location to the signal generator to facilitate beam-steering.

12. A charging nest for wireless charging, comprising:
a housing that is circular or ring-shaped;
a plurality of antennas arranged about a periphery of the housing;
at least one signal generator and at least one RF power amplifier electrically coupled to the plurality of antennas; and
at least one sensor electrically coupled to the at least one signal generator, wherein the at least one sensor is configured to detect a device-for-charging (“DFC”) and a location associated with a receiver coupled to the DFC and to communicate the location to the signal generator to facilitate beam-steering.

13. The charging nest according to claim 12, wherein the plurality of antennas are single-loop antennas, slot antennas, dipole antennas, and/or Yagi-Uda antennas.

14. The charging nest according to claim 12, wherein the plurality of antennas are spaced equidistant from each other about the periphery of the housing.

15. The charging nest of claim 12, further comprising:
a primary single-loop antenna circumscribed by the plurality of antennas.

16. The charging nest according to claim 15, wherein the primary single-loop antenna has an aperture arranged in a vertical direction and the plurality of antennas have apertures arranged in different directions.

17. The charging nest according to claim 15, wherein the plurality of antennas are single-loop antennas and have the same diameter, and wherein the primary single-loop antenna has a larger diameter than each of the plurality of antennas.

18. The charging nest according to claim 12, further comprising:
a plurality of repeaters coupled to the housing that receive signals from the plurality of antennas and that retransmit the signals to at least one DFC.

19. The charging nest according to claim 12, further comprising:
a plurality of receivers or transceivers electrically coupled to the at least one signal generator such that the plurality of receivers harvest signals from ambient microwaves in a surrounding environment.

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)
